(19) United States
(12) Patent Application Publication
(10) Pub. No.: US 2019/0355105 A1
(43) Pub. Date: Nov. 21, 2019

(54) METHOD AND DEVICE FOR BLIND CORRECTION OF LATERAL CHROMATIC ABERRATION IN COLOR IMAGES

(71) Applicant: SONY MOBILE COMMUNICATIONS INC., Tokyo (JP)

(72) Inventors: Jim RASMUSSON, Vellinge (SE); Stefan PETERSSON, Lyckeby (SE); Håkan GRAHN, Karlskrona (SE)

(21) Appl. No.: 16/472,169

(22) PCT Filed: Jan. 27, 2017
(86) PCT No.: PCT/EP2017/051783

§ 371 Date: Jun. 20, 2019

(51) Int. Cl. G06T 5/00

(52) U.S. Cl. CPC G06T 5/006; G06T 2207/10024; G06T 2207/20072; G06T 2207/20021; G06T 2207/20016

(57) ABSTRACT

A digital color image is processed for correction of lateral chromatic aberration in a current color plane (CCP). The processing identifies (502), within each of a plurality of predetined search regions distributed over the image, selected blocks comprising intensity edge(s) in both CCP and a reference color plane (RCP). The processing further determines (503), for each selected block in CCP, a radial scaling factor that minimizes a measure of difference between the intensity edges in CCP and RCP, and processes (504) the redial scaling factors of the selected blocks to determine a spatial scaling function that relates radial scaling to radial distance from an image reference point. The processing further recalculates (505) color values in CCP by computing an interpolated color value for each image pixel at an updated pixel location given by the spatial scaling function for the respective image pixel. The method may be operated on a mosaiced or a demosaiced image.

### TECHNICAL FIELD

The present invention relates generally to digital image processing, and particularly to techniques for blind correction of lateral chromatic aberration in color images.

### BACKGROUND ART

Optical color images are commonly distorted by various types of optical aberrations caused by the imaging optics. One of these aberrations resulting in color artefacts is denoted chromatic aberration (CA). It occurs because lenses, typically made of glass or plastic, bear different refractive indices for different wavelengths of light (the dispersion of the lens). The refractive index decreases with increasing wavelength. The main consequence of CA in imaging is that light rays at different wavelengths are focused at different image distances (axial/longitudinal CA) and at different locations in the image (transverse/lateral CA).

A digital color image is made up of a plurality of color channels, typically three, and lateral CA causes the color channels to be misaligned with respect to each other and manifests itself as colored fringes at image edges and high contrast areas in the optical color image.

Chromatic aberration may be observed in most optical devices that use a lens. In manufacturing of the lens used in the optical devices, various lenses are combined to correct the chromatic aberration. However, even if the lenses are combined, chromatic aberration cannot be completely cancelled. Also, in most cameras installed in mobile phones and typical compact cameras, inexpensive lenses are used and thus, chromatic aberration may be more conspicuous. Moreover, although resolutions of cameras installed in mobile phones and digital cameras are rapidly increasing, lens quality does not proportionally increase due to cost and size of the lenses.

These types of imaging artifacts are unacceptable in professional photography. Software programs that enable correction of imaging artifacts by post-processing of digital color images are readily available, including Adobe PhotoShop Lightroom CC®, Adobe Camera Raw®, DxO Optics Pro® and PTLens®. Such software programs apply so-called non-blind corrections, in that they use pre-calibrated correction parameters for the specific combination of camera and lens that was used to capture the image to be corrected. It is realized that the non-blind correction techniques must have access to a huge database of corrections parameters for all possible combinations of cameras and lenses. Such a database takes a lot of effort to generate and must be constantly updated to account for new models of cameras and lenses, and combinations thereof.

There is therefore a need for blind techniques which are capable of correcting color images for aberrations, including lateral CA, without prior knowledge about the color image and how it was generated. Software programs for blind correction of lateral CA are known in the art, e.g. Photo Ninja. Further, US2013/0039573 discloses a method for blind correction of CA in an RGB image, including lateral CA. The method first detects a CA occurrence region in the image and estimates a coefficient that minimizes a difference between a size of pixels of an edge of an R channel and size of pixels of an edge of B channel. The method then calculates a pixel value that minimizes a difference between sizes of edges of RGB channels, by using the estimated coefficient, and moves the edges of the R channels and the edges of the B channels included in the CA occurrence region to a position that corresponds to the pixel value.

There is a general desire to provide alternative techniques for blind correction of lateral CA, especially such a technique that is computation efficient and capable of providing a significant reduction of lateral CA in a digital color image.

### BRIEF SUMMARY

It is an objective of the invention to at least partly overcome one or more limitations of the prior art.

Another objective is to provide an alternative technique for blind correction of lateral chromatic aberration.

A further objective is to provide such a technique suitable for real-time processing of digital images.

One or more of these objectives, as well as further objectives that may appear from the description below, are at least partly achieved by a computer-implemented method for correction of lateral chromatic aberration, a computer-readable medium, and a device for correction of lateral chromatic aberration according to the independent claims, embodiments thereof being defined by the dependent claims.

A first aspect of the invention is a computer-implemented method of processing a digital color image for correction of lateral chromatic aberration, the digital color image comprising color values in a first, second and third color plane, image pixels of the digital color image being associated with a color value in at least one of the first, second and third color planes. The method comprises, for a current color plane among the second and third color planes: identifying, in the digital color image, selected blocks comprising one or more intensity edges in both the current color plane and the first color plane, wherein the selected blocks are identified within each of a plurality of predefined search regions distributed over the digital color image; determining, for each selected block, a radial scaling factor for the current color plane, the radial scaling factor being determined to minimize a measure of difference between the one or more intensity edges in the current color plane and the one or more intensity edges in the first color plane; processing the radial scaling factors of the selected blocks to determine a spatial scaling function that relates radial scaling to radial distance from an image reference point of the digital color image; and recalculating color values of the current color plane for at least a subset of the image pixels by computing an interpolated color value for the respective image pixel at an updated pixel location given by the spatial scaling function for the respective image pixel.

Additionally, in some embodiments, each search region is associated with a block number limit, which defines a maximum number of selected blocks to be identified within the search region.

Additionally, in some embodiments, the search regions comprise ring-shaped regions centered on the image reference point and located at different radial distances from the image reference point.

Additionally, in some embodiments, search regions are defined by cells in a predefined grid structure.

Additionally, in some embodiments, each search region comprises predefined computation blocks, and the step of identifying the selected blocks comprises: identifying, for each search region, the selected blocks as a subset of the computation blocks that contain the relatively largest intensity edges in both the current color plane and the first color plane.

Additionally, in some embodiments, the digital color image is a mosaiced image in which each image pixel is associated with a color value in one of the first, second and third color planes, wherein each intensity edge in each of the current color plane and the first color plane is represented by a range value for color values of image pixels in the current color plane and the first color plane, respectively.

Additionally, in some embodiments, the method further comprises: obtaining an edge image for each of the current color plane and the first color plane, the edge image comprising edge pixels that spatially correspond to the image pixels in the digital color image, wherein each edge pixel in the current color plane and the first color plane has an edge value representing an intensity gradient within a local region of the spatially corresponding image pixel in the current color plane and the first color plane, respectively, and wherein the selected blocks are identified based on the edge images in the current color plane and the first color plane.

Additionally, in some embodiments, each search region comprises predefined computation blocks, and the step of identifying the selected blocks comprises: computing, for each of the current color plane and first color plane, a characteristic value for each computation block as a function of the edge values for the edge pixels within the computation block, and identifying, for the respective search region, the selected blocks as function of the characteristic values of the computation blocks in the current color plane and the first color plane.

Additionally, in some embodiments, the characteristic value comprises at least one of a maximum, an average and a median.

Additionally, in some embodiments, the computation blocks are processed for elimination of computation blocks dominated by a radial intensity edge in at least one of the current color plane and the first color plane, the radial intensity edge being located to be more parallel than transverse to a radial vector extending from the image reference point to a reference point of the respective computation block.

Additionally, in some embodiments, the elimination of computation blocks dominated by a radial intensity edge further comprises, for each computation block: defining one or more internal block vectors that extend between the edge pixels that have the largest edge values within the computation block; determining an angle parameter representing one or more angles between the radial vector and the one or more internal block vectors; and comparing the angle parameter to a predefined threshold.

Additionally, in some embodiments, the step of identifying the selected blocks comprises: selecting a subset of the computation blocks, and forming the selected blocks by redefining the extent of each computation block in the subset so as to shift a center point of the computation block towards a selected edge pixel within the computation block.

Additionally, in some embodiments, the selected edge pixel has the largest edge value within the computation block for at least one of the current color plane and the first color plane.

Additionally, in some embodiments, the step of identifying the selected blocks comprises: preparing a first list of a predefined number of computation blocks within the respective search region sorted by characteristic value in the current color plane, preparing a second list of the predefined number of computation blocks within the respective search region sorted by characteristic value in the first color plane, and selecting the selected blocks within the respective search region as the mathematical intersection of the first and second lists, wherein the predefined number is set to the block number limit.

Additionally, in some embodiments, the step of identifying the selected blocks comprises: computing a comparison parameter value as a function of the characteristic values in the current color plane and the first color plane for each computation block within the respective search region; and selecting, for the respective search region, a predefined number of computation blocks based on the comparison parameter values, wherein the comparison parameter value is computed to indicate presence of significant intensity edges in both the current color plane and the first color plane, and wherein the predefined number does not exceed the block number limit for the respective search region.

Additionally, in some embodiments, the step of identifying the selected blocks further comprises: adding the computation blocks to a hierarchical spatial data structure, such as a quadtree, corresponding to the digital color image, wherein the hierarchical spatial data structure is assigned a depth that defines the extent and location of the computation blocks, and a bucket limit that corresponds to the block number limit.

Additionally, in some embodiments, the step of determining the radial scaling factor comprises: repeatedly applying different test factors to edge values of edge pixels within the selected block, computing the measure of difference for each test factor, and selecting the radial scaling factor as a function of the test factor yielding the smallest measure of difference.

Additionally, in some embodiments, each test factor is applied by computing radially offset locations for selected locations within the selected block, generating interpolated edge values at the radially offset locations in the current color plane, obtaining reference edge values at the selected locations in the first color plane, and computing the measure of difference as a function of the interpolated edge values and the reference edge values.

Additionally, in some embodiments, the selected locations comprise reference points of edge pixels distributed within the selected block.

Additionally, in some embodiments, the selected locations comprise a pixel reference point of a selected edge pixel within the selected block and auxiliary points distributed along a radial direction from the image reference point to the pixel reference point.

Additionally, in some embodiments, the edge value for the respective edge pixel in the current color plane and the reference color plane is a range value for the color values within the local region of the spatially corresponding image pixel in the current color plane and the first color plane, respectively.

Additionally, in some embodiments, the digital color image is a mosaiced image.

Additionally, in some embodiments, the mosaiced image is a Bayer image and the first color plane is green.

Additionally, in some embodiments, the spatial scaling function is determined by adapting one or more coefficients of a predefined function, which relates radial scaling to radial distance, to data pairs formed by the radial scaling factors and radial distances for the selected blocks.

A second aspect of the invention is a computer-readable medium comprising computer instructions which, when executed by a processor, cause the processor to perform the method of the second aspect or any of its embodiments.

A third aspect of the invention is a device for processing a digital color image for correction of lateral chromatic aberration, the digital color image comprising color values in a first, second and third color plane, image pixels of the digital color image being associated with a color value in at least one of the first, second and third color planes. The device is configured to, for a current color plane among the second and third color planes: identify, in the digital color image, selected blocks comprising one or more intensity edges in both the current color plane and the first color plane, wherein the selected blocks are identified within each of a plurality of predefined search regions distributed over the digital color image; determine, for each selected block, a radial scaling factor for the current color plane, the radial scaling factor being determined to minimize a measure of difference between the one or more intensity edges in the current color plane and the one or more intensity edges in the first color plane; process the radial scaling factors of the selected blocks to determine a spatial scaling function that relates radial scaling to radial distance from an image reference point of the digital color image; and recalculate color values of the current color plane for at least a subset of the image pixels by computing an interpolated color value for the respective image pixel at an updated pixel location given by the spatial scaling function for the respective image pixel.

The device of the third aspect may alternatively be defined to comprise: means for identifying, in the digital color image, selected blocks comprising one or more intensity edges in both the current color plane and the first color plane, wherein the selected blocks are identified within each of a plurality of predefined search regions distributed over the digital color image; means for determining, for each selected block, a radial scaling factor for the current color plane, the radial scaling factor being determined to minimize a measure of difference between the one or more intensity edges in the current color plane and the one or more intensity edges in the first color plane; means for processing the radial scaling factors of the selected blocks to determine a spatial scaling function that relates radial scaling to radial distance from an image reference point of the digital color image; and means for recalculating color values of the current color plane for at least a subset of the image pixels by computing an interpolated color value for the respective image pixel at an updated pixel location given by the spatial scaling function for the respective image pixel.

The second and third aspects share the advantages of the first aspect. Any one of the above-identified embodiments of the first aspect may be adapted and implemented as an embodiment of the second and third aspects.

Still other objectives, features, aspects and advantages of the present invention will appear from the following detailed description, from the attached claims as well as from the drawings.

### BRIEF DESCRIPTION OF DRAWINGS

Embodiments of the invention will now be described in more detail with reference to the accompanying schematic drawings.

FIG. 1 is a block diagram of a digital camera system utilizing a correction technique in accordance with exemplary embodiments of the present invention.

FIG. 2 illustrates an exemplary filter unit of a color filter array.

FIG. 3 illustrates a mosaiced color image and its constituent color planes.

FIG. 4 illustrates a demosaiced color image with lateral CA.

FIG. 5 is a flow chart of a method for correction of lateral CA according to one embodiment.

FIG. 6 is a flow chart of a method for correction of lateral CA of a Bayer image according to a detailed embodiment.

FIG. 7 is a flow chart of a method for computation of SI values.

FIGS. 8(A)-8(D) illustrate the location of red, green and blue pixels within a local region centered on a current pixel, depending on the color of the current pixel.

FIG. 9 illustrate steps of forming SI images and identifying selected blocks in predefined search regions.

FIGS. 10(A)-10(F) show further examples of search regions.

FIG. 11 illustrates sorted block tables used for identifying selected blocks within a search region.

FIG. 12 illustrate a step of discriminating between blocks having transverse edges and blocks having radial edges.

FIG. 13 illustrate a step of redefining selected blocks.

FIGS. 14(A)-14(B) illustrate methods for computing a radial scaling factor for a selected block.

FIG. 15 is an example graph of a spatial scaling function determined for a plurality of radial scaling factors.

FIGS. 16(A)-16(B) illustrate a method of computing updated color values for a Bayer image based on the spatial scaling function.

### DETAILED DESCRIPTION OF EXAMPLE EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Embodiments of the present invention generally relate to a technique or algorithm for blind correction of lateral chromatic aberration (CA) in digital color images, typically digital color images captured by an image sensor fitted with a color filter array (CFA). The correction algorithm may be implemented by any digital imaging device, such as a digital camera, video camera, mobile phone, medical imaging device, etc. On the digital imaging device, the correction algorithm may be operated on-line to process images in real-time, i.e. the correction algorithm receives a stream of images from an image sensor and produces a corresponding stream of processed images for display or further processing. The correction algorithm may also be operated off-line on the digital imaging device for post-processing of stored images. The correction algorithm need not be implemented on a digital imaging device, but could be implemented on any type of computer system, such as a personal computer or server, for processing of digital images.

All methods disclosed herein may be implemented by dedicated hardware, such as an ASIC (application specific integrated circuit) or an FPGA (field programmable gate array), optionally in combination with software instructions executed on a dedicated or generic processor. Alternatively, the demosaicing may be implemented purely by such software instructions. The processor for executing the software instructions may, e.g., be a microprocessor, microcontroller, CPU, DSP (digital signal processor), GPU (graphics processing unit), etc, or any combination thereof. The software instructions may be supplied on a computer-readable medium for execution by the processor in conjunction with an electronic memory. The computer-readable medium may be a tangible (non-transitory) product (e.g. magnetic medium, optical disk, read-only memory, flash memory, etc) or a propagating signal.

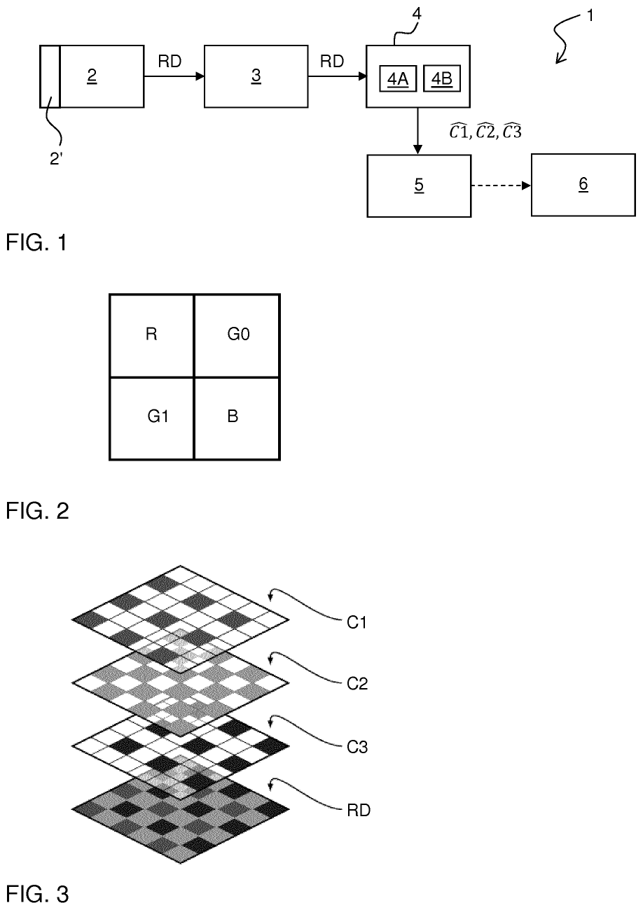

An example environment for the correction algorithm is depicted in FIG. 1, which shows a digital camera system 1 that operates a demosaicing algorithm for on-line processing of raw data RD produced by a digital image sensor 2. The digital image sensor 2, e.g. a CMOS sensor chip or a CCD sensor chip, includes a two-dimensional array of pixels arranged in rows and columns. The digital image sensor 2 has a color filter array (CFA) 2′, which covers the two-dimensional array of pixels such that each pixel senses only one color. For example, the CFA 2′ may be a Bayer CFA, in which chrominance colors (red and blue) are interspersed amongst a checkerboard pattern of luminance colors (green). A Bayer CFA is formed by tiling a filter unit across the image sensor to cover a respective group of pixels. An example of such a filter unit covering 2×2 pixels is shown in FIG. 2. As seen, the filter unit is made up of two green filters G0, G1, one red filter R and one blue filter B. It should be understood that the filter unit in FIG. 2 is merely given as an example and that other arrangements of the filters G0, G1, R, B within the filter unit are conceivable. Further, the Bayer CFA may alternatively be defined to separate incoming light into other color spaces, such as CMY (cyan, magenta, yellow). Generally, the image sensor 2 may be provided with any type of CFA 2′ that causes the image sensor 2 to produce raw data in the form of a mosaiced image, including but not limited to GRGB filters, CYGM filters, RGBE filters, etc in which the filter units may have any size (2×2, 3×3, 4×4, etc). Many variants are well-known to the person skilled in the art and will not be further described herein.

For the Bayer CFA 2′ formed by the filter unit in FIG. 2, the digital image sensor 2 produces raw data RD containing the original red, blue and green pixel values. Such raw data RD is thus a mosaiced image, also known as a “Bayer image” when originating from a Bayer CFA. As shown in FIG. 3, the mosaiced image RD may be seen to be formed by three separate and superimposed base color planes C1, C2, C3 (e.g. R, G and B). In the digital camera system 1 of FIG. 1, the raw data RD is provided to a digital processing arrangement 4 which comprises a demosaicing unit 4A and a correction unit 4B. The correction unit 4B is configured to operate a correction algorithm in accordance with embodiments of the present invention for blind correction of lateral CA, either by pre-processing the raw data RD before demosaicing or by post-processing the demosaiced color image produced by the demosaicing unit 4A. The demosaicing unit 4A may operate any available demosaicing algorithm on the raw data RD (optionally pre-processed by the correction unit 4B) in order to interpolate the pixel values to obtain red, green and blue values at each pixel location. Demosaicing algorithms are well-known to the skilled person and include, e.g., pixel replication, bilinear interpolation, bicubic interpolation, spline interpolation, Lanczos resampling, smooth hue transition interpolation, gradient-corrected bilinear interpolation (e.g. Malvar), as well as various adaptive demosaicing algorithms.

The raw data RD is typically provided to the digital processing arrangement 4 in blocks at a time. Thus, the raw data RD may be stored in a buffer 3 until the requisite amount of raw data RD is present to begin processing by the digital processing arrangement 4. The amount of raw data RD needed to begin processing depends on the type of processing. For example, pixel values are typically read off the sensor 2 one row at a time. For a neighborhood interpolation of a given pixel to begin, at least one horizontal pixel neighbor, and preferably, one vertical pixel neighbor are stored within the buffer 3. In addition, since some digital cameras take multiple images to ensure the exposure is correct before selecting the image to permanently store, one or more images may be stored in the buffer 3 at a time.

The demosaicing in the digital processing arrangement 4 results in three interpolated base color planes [symbol] , each containing the original values and interpolated values. The interpolated red, green and blue color planes [symbol] collectively form a demosaiced image and may be stored in a memory 5 until displayed or further processed. It should be noted that the color planes [symbol] may be compressed using any compression method prior to being stored in the memory 5. The compression method may be lossy but is preferably lossless, such as PNG compression or a block compression method. To display or process the compressed data on an output device 6 (e.g., a display, printer, computer, etc), the compressed data may be first decompressed before being provided to the output device 6. It is also conceivable that the raw data RD is also stored in memory 5 for subsequent retrieval.

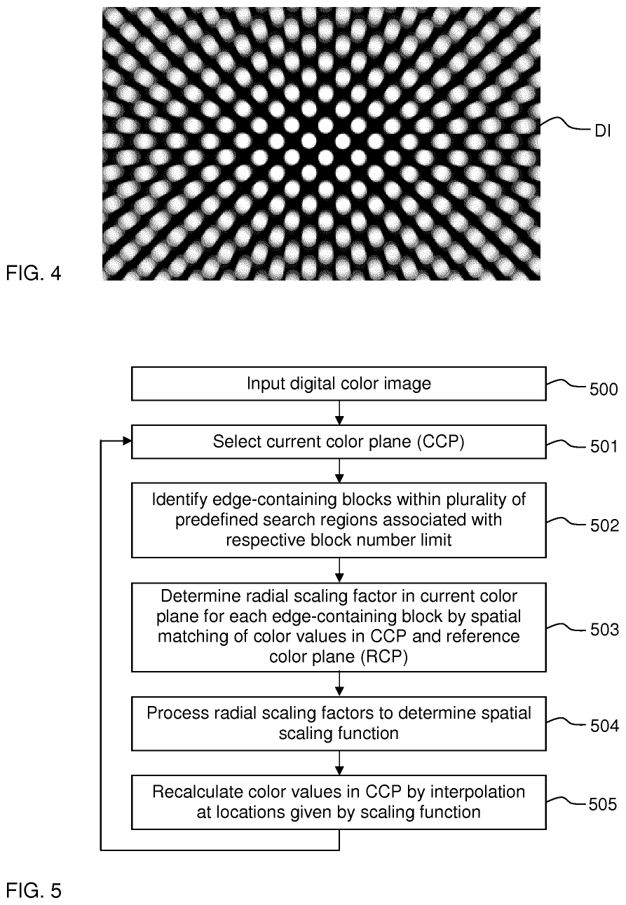

FIG. 4 shows an example of a demosaiced image DI which has not be processed for correction of lateral CA and therefore exhibits significant lateral CA in form of color fringes caused by relative shifts between the color planes [symbol] . In the grayscale representation of FIG. 4, the color fringes are seen as an increased blurriness towards the edges of the image DI and this blurriness is radially symmetric. Thus, there is often radial symmetry in the lateral CA in the image. Embodiments of the invention capitalize on this radial symmetry of the lateral CA

and involve a concept of first determining a spatial scaling function that relates radial scaling (magnification) to radial distance from a reference point in a digital image (“image reference point”, IRP), typically its center point, and then using the spatial scaling function to recalculate color values of pixels in one or more base color planes of the digital image. In practice, this means that the respective color plane is rescaled so as to eliminate or suppress the color fringes in the demosaiced image. The spatial scaling function is determined without prior knowledge of the image capturing device and is thus blind.

It should also be noted that the step of determining the spatial scaling function need not be executed for each digital image to be corrected. In the example of FIG. 1, the spatial scaling function may be assumed to be accurate also for subsequent images taken by the digital camera system 1, as long as the user does not change the configuration of the camera, e.g. by changing lens, zoom factor, focal point, etc. Thus, under certain circumstances and depending on the required accuracy of the correction, the spatial scaling function may be determined for one or more digital images RD, DI, stored in memory, and used for correction of these images as well as subsequent digital images RD, DI.

To achieve proper accuracy of the spatial scaling function, and thus of the correction for lateral CA, it may be desirable to ensure that the spatial scaling function is determined based on image information at many different radial distances to IRP. Further, the assumption of radial symmetry with respect to IRP is only strictly valid if IRP coincides with the optical axis of the imaging system. However, in practice, IRP is typically offset from the optical axis, e.g. due to manufacturing and mounting tolerances of the camera and the lens, which makes the assumption of radial symmetry with respect to IRP slightly inaccurate. To reduce the impact of this offset, it may be desirable to increase the likelihood that the spatial scaling function is determined based on information from parts that are well-distributed both radially and angularly over the image.

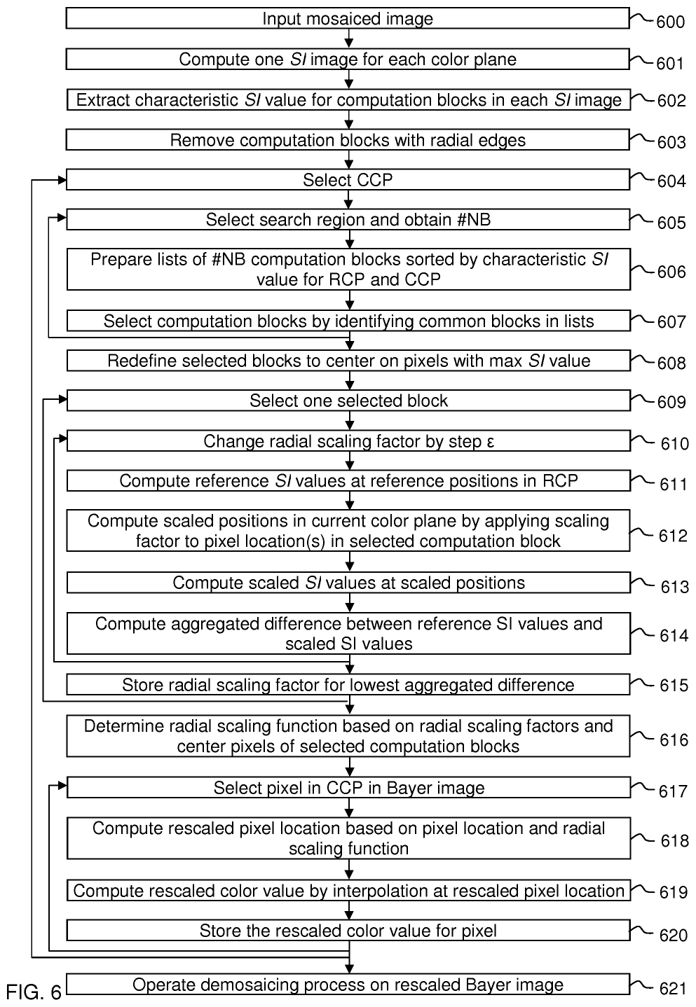

FIG. 5 is a flow chart of a correction method that may be implemented by the correction unit 4B. The individual steps 500-505 will be further exemplified below with reference to a detailed implementation example in FIG. 6.

In step 500, a digital color image is input. As noted with reference to FIG. 1, the correction method (and thus the correction unit 4B) may operate on either a mosaiced image (cf. RD in FIG. 1) or a demosaiced image (cf. DI in FIG. 4). As noted above, the image need not be input in its entirety but may be processed in sections, e.g. in one or more rows. In the correction method, one of the base color planes is used as a reference, and the other base color planes are rescaled with respect to the reference color plane (RCP), which is thus considered to be correct. In the following examples, the green color plane (C2) is used as reference color plane. The choice of the green color plane as reference is partly motivated by the fact that the wavelength of green color falls between the wavelengths of red and blue colors, which means that the effect of lens dispersion can be expected to be larger for red and blue than for green. Further, at least in the example of a mosaiced (Bayer) image (cf. FIG. 2), there are more green pixels (50%) than red pixels (25%) or blue pixels (25%). Another reason for selecting the green color plane as reference is that the sensitivity of the human visual system peaks in the green color range.

In step 501, the method sets a current color plane (CCP) to be processed, among the base color planes. In the examples herein, CCP is set to one of the red and blue color planes. The method performs steps 502-505 on CCP, and then repeats steps 502-505 on the other color plane as CCP. Steps 502-505 implement the above concept of determining a spatial scaling function for CCP and recalculating the color values in CCP by means of the spatial scaling function.

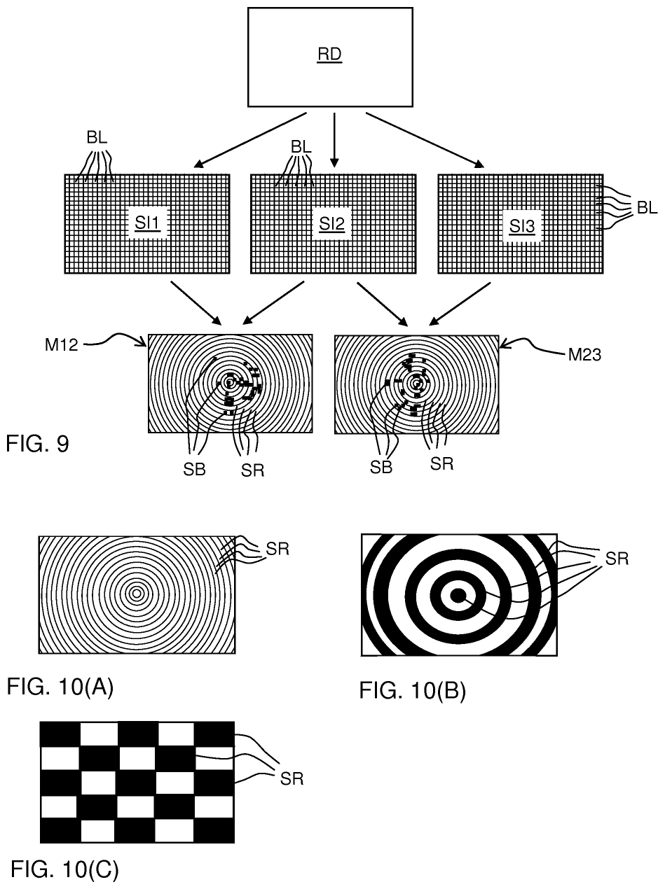

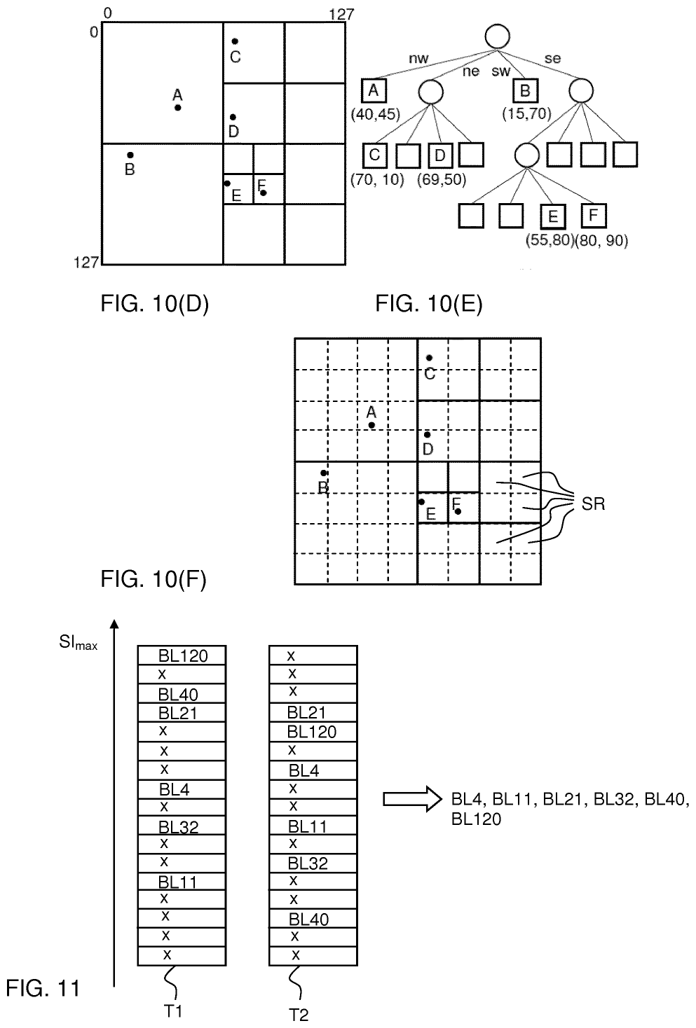

In step 502, the method identifies selected blocks (“edge-containing blocks”) within a plurality of predefined search regions that are distributed across the image, where each edge-containing block includes an intensity edge (gradient) in both CCP and RCP. The edge-containing blocks are subsequently processed, in step 503 (below), to provide radial scaling factors which are processed, in step 504 (below), to yield the spatial scaling function. As noted above, it is desirable to increase the likelihood that the radial scaling factors and thus the edge-containing blocks are well-distributed over the image, at least radially, or both radially and angularly. For processing efficiency, it is also important to restrict the number of edge-containing blocks to be processed in step 503. Both of these objectives are achieved by assigning a respective block number limit (#NB) to each search region, where the block number limit defines the maximum number of edge-containing blocks block that can be identified within the respective search region. This means that even if the image contains strong edges confined to one or a few search regions, step 503 is likely to restrict the number of edge-containing blocks in these search regions and also seek to identify edge-containing blocks within other search regions, to provide radial scaling factors that are well-distributed across the image. Examples of search regions and their use are given in FIGS. 9-10 and will be discussed in more detail in connection to FIG. 6.

Step 502 may use any type of edge detection technique to identify edges within computation blocks that are distributed across the search regions, where each computation block comprises a plurality of pixels. The computation blocks suitably have identical size, e.g. 8×8, 16×16, 32×32 or 64×64 pixels, and identical location in all color planes. The edge detection technique may assign an edge intensity to each computation block to indicate the magnitude of the edge (if any) within the respective computation block.

Step 502 may be implemented to search the plurality of computation blocks for edges within both RCP and CCP , and to return no more than the predefined number (#NB) of edge-containing blocks for each search region. The edge-containing blocks may be selected to include the strongest edges in RCP, the strongest edges in the CPP, or a combination thereof. In one embodiment, this is achieved, for each search region, by generating a first list containing the maximum number (#NB) of computation blocks in RCP as sorted by decreasing edge intensity, generating a second list containing the maximum number of computation blocks in CCP as sorted by decreasing edge intensity, and identifying the edge-containing blocks as the computation blocks that are included in both the first and second lists.

In step 503, a radial scaling factor for CCP is determined for each edge-containing block by spatial matching of scaled color values in CCP to reference color values in RCP. This may be achieved by applying different radial scaling factors to selected locations within the edge-containing block thereby producing scaled locations, generating interpolated color values (scaled color values) in CCP at the scaled locations and comparing the scaled color values in CCP to the reference color values in RCP at the selected locations, and selecting the radial scaling factor that minimizes the difference between the color values in CCP and RCP. Any commonly used interpolation function may be used to generate the scaled color values, including but not limited to bilinear, bicubic, sinc, lanczos, Catmull-Rom, Mitchell-Netravali, Pocs (Projections onto convex sets), RSR (Robust Super Resolution) and ScSR (Sparse-coding based Super Resolution).

In step 504, the radial scaling factors for the edge-containing blocks are processed to determine coefficients of the spatial scaling function, e.g. by fitting the radial scaling factors to an n:th degree polynomial, or any other predefined function.

In step 505, color values of image pixels in CCP are recalculated by interpolation in CCP at scaled pixel locations given by the spatial scaling function. This may be achieved by applying the spatial scaling function to each relevant pixel location in CCP thereby producing a scaled pixel location, generating an interpolated color value in CCP at the scaled pixel location, and replacing the original color value of the image pixel for the interpolated pixel value. The interpolated color value may be generated by any of the above-mentioned interpolation functions.

If a demosaiced image is processed by the correction method in FIG. 5, by use of all color values in the color planes, the original green color plane and the resulting interpolated red and blue color planes form a demosaiced image corrected for lateral CA. If a mosaiced image is processed by the correction method, the original green color plane and the resulting interpolated red and blue color planes form a corrected mosaiced image, which may be processed by any demosaicing algorithm to yield a corrected demosaiced image. It is currently believed that a better correction of lateral CA is obtained by processing the mosaiced image compared to the demosaiced image. The demosaicing introduces a certain amount of blurring, which may disturb the correction of lateral CA by steps 501-505. If a demosaiced image should be processed for correction of lateral CA, it may be better to ignore the interpolated color values of the demosaiced image, and thus process the demosaiced image as if it were a mosaiced image to produce a corrected mosaiced image, which may then be subjected to demosaicing to produce a corrected demosaiced image.

Effectively, the same steps 501-505 are executed for correction of both a mosaiced and a demosaiced image, although the implementation of one or more steps may differ, e.g. step 502. Edge detection in the respective color plane of a demosaiced image, by use of all color values in the color plane, is a relatively simple task and there are numerous available edge detection algorithms that may be used. In a mosaiced image, edge detection is a more complex task, since the color information in the color planes is more sparse and there are no overlapping color values between the color planes (cf. FIG. 3).

In the following, a detailed implementation of the correction method in FIG. 5 for correction of a mosaiced image, exemplified by a Bayer image, will be presented with reference to FIG. 6. The correction method is equally applicable to processing of a demosaiced image, if the method is implemented to ignore the interpolated pixels in the demosaiced image.

The method in FIG. 6 utilizes a specific metric for detecting and representing edges, namely the “structural instability” in a local region of the respective pixel in the respective color plane. As used herein, structural instability (SI) is a measure of the variability or roughness in the local region of the respective pixel. Typically, SI is computed for every pixel in the mosaiced image, and it is desirable to obtain SI at a minimum of operations. In the embodiments presented herein, the structural instability is obtained as the range of color values in the local region of the respective pixel (including the pixel). The range is a well-known and simple measure that may be computed in an efficient way. Specifically, the range of a set of data is given by the difference between the largest and smallest values in this set. Thus, in embodiments of the invention, the structural instability for a set of n color values {s₀, . . . , sₙ₋₁} is given by:

SI=MAX(s₀, . . . , sₙ₋₁)−MIN(s₀, . . . , sₙ₋₁), (1)

where MAX and MIN are functions for determining the maximum value and the minimum value, respectively, in the set of values. For example, if each color is defined by 8 bits in the mosaiced image, SI has a value between 0 and 255.

The method in FIG. 6 starts by inputting a Bayer image (step 600, corresponding to step 500). The Bayer image is processed for generation of an SI image for each color plane (step 601). There is a 1:1 correspondence between SI pixels in the SI image and image pixels in the Bayer image. Each SI pixel in the SI image for the respective color plane is associated with an SI value given by the range in a local region of the corresponding image pixel in the color plane.

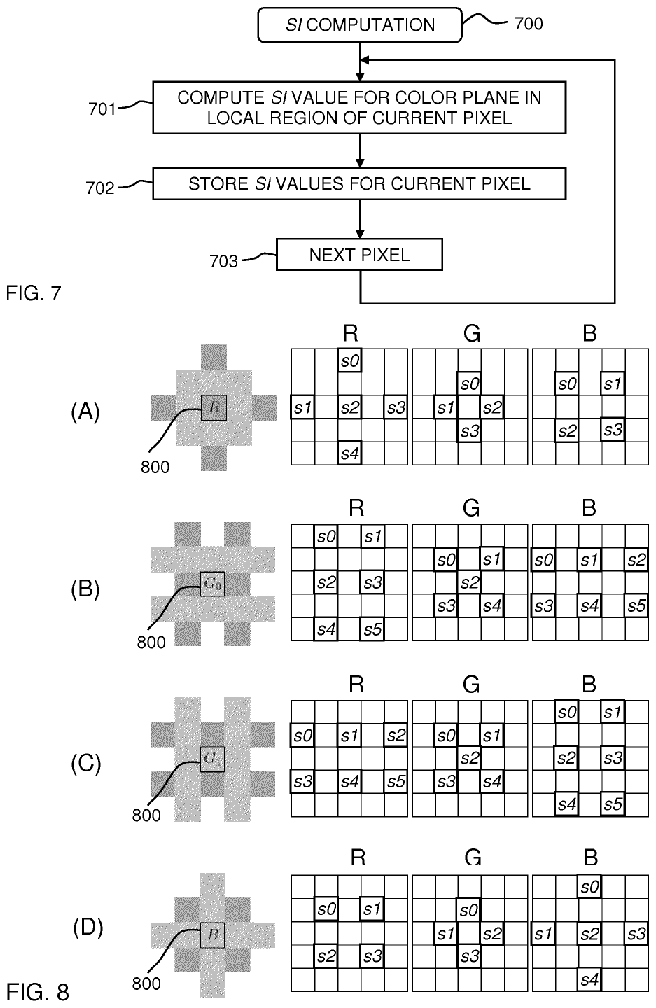

FIG. 7 is a flow chart of a generic method 700 for computing an SI image for a color plane of a mosaiced image. The method 700 operates on the mosaiced image pixel by pixel. In step 701, an SI value is computed in the local region of the current pixel in the color plane, according to Eq. (1) above. The SI value thereby represents the structural instability in the color plane in the neighborhood of the current pixel. In step 702, the SI value is stored in electronic memory (e.g. buffer 3 or memory 5 in FIG. 1) for the current pixel. The association between SI value and pixel may be implicit or explicit in the memory. In step 703, the method proceeds to the next pixel in the mosaiced image.

It is preferable that each SI value represents color values in two dimensions around the current pixel. For reasons of processing efficiency, it may also be preferable to implement step 701 in FIG. 7 to use local regions that are coherent, fixed and predefined with respect to the current pixel. It can be shown that for Bayer images, these requirements are fulfilled provided that the local regions comprise at least 5×5 pixels and are centered on the current pixel. Thus, a local region of 5×5 pixels yields the shortest distance to the center value (i.e. the current pixel) with two degrees of freedom in the respective color plane and symmetry with respect to the center value. In other words, for a 5×5 region, the SI values may be computed for the current pixel (if populated with a color value) and the nearest neighbors in both the horizontal direction and the vertical direction from current pixel. This principle is illustrated in FIG. 8, which shows the location of the red (R), green (G) and blue (B) color values within a local region of 5×5 pixels depending on the current color at the current pixel 800. Specifically, the current pixel 800 is red (R) in FIG. 8(A), green (G0) in FIG. 8(B), green (G1) in FIG. 8(C) and blue (B) in FIG. 8(D). Thus, step 701 may be configured to compute the SI value for a specific current color at the current pixel 800 and a specific color plane (R, G, B) based on the respective set of color values {s₀, . . . , sₙ₋₁} indicated in FIG. 8. It is understood that the correction unit 4B (FIG. 1) may be programmed or configured to efficiently perform step 701 based on the data in FIG. 8. It is conceivable that the SI values are calculated for a local region defined to include further neighbors, such as the second nearest neighbors, e.g. a local region of 7×7 pixels. However, it is currently believed a local region of 5×5 pixels is a good compromise between processing cost and performance. If the local region is smaller than 5×5 pixels, which is possible, at least some SI values will not represent neighboring pixels located symmetrically in two dimensions to the current pixel, as understood from FIG. 8.

Reverting to FIG. 6, step 602 generates at least one characteristic value for predefined computation blocks in the respective SI image. The computation blocks were discussed above in relation to step 502 of FIG. 5. The characteristic value(s) may be a one or more of the largest SI values within the computation block, e.g. the largest SI value or the two largest SI values, or an average or median of the SI values within the computation block. FIG. 9 illustrates a raw (mosaiced) image RD and the associated SI images SI1, SI2, SI3 for the color planes C1 (red), C2 (green), C3 (blue). The grid in the respective SI image SI1, SI2, SI3 represents the computation blocks BL. As noted above, each computation block BL comprises a plurality of image pixels and thus SI pixels.

In a more general description, step 602 involves generating a respective “edge image” for each CCP and RCP, where the edge image is made up of “edge pixels”, which correspond spatially to the image pixels and are associated with a respective “edge value” that represents the intensity gradient within the local region of the spatially corresponding image pixel. Thereby, each edge pixel may be seen to represent and quantify an “edge element” (intensity step/gradient) in the vicinity of the corresponding image pixel. The edge image may be defined with a 1:1 correspondence between edge pixels and image pixels, although other correspondences are conceivable. In the examples presented herein for the method in FIG. 6, there is a 1:1 correspondence and the edge values are range values (SI values) for the local regions as defined in FIG. 8.

The two step procedure according to steps 602 and 603 of first acquiring edge values within a local region of the respective image pixel and then acquiring the characteristic value(s) among the edge values within a computation block comprising a plurality of edge pixels, allows for precise quantification of edge elements in the immediate vicinity of individual image pixels and makes it possible to correlate or match the location of edges in different color planes for determination of radial scaling factors (steps 609-615, below). Further, the provision of detailed information about the location of edge elements within the computation blocks enables refined processing, such as analysis of the direction of edges within the computation blocks (step 603, below) and using the location of the strongest edge element within each computation block to define blocks to be used when determining the radial scaling factors (step 608, below).

Reverting to FIG. 6, step 603 processes the computation blocks to select only computation blocks that are dominated by tangential edges and thereby to exclude from further processing computation blocks that are dominated by radial edges. As used herein, a “tangential edge” is an edge that is more transverse than parallel to a radial vector, which extends from the above-mentioned IRF. Conversely, a “radial edge” is an edge that is more parallel than transverse to the radial vector. Step 603 reduces the computational load by reducing the number of computation blocks to be processed in subsequent steps, without any significant loss of information since experiments indicate that tangential edges contain more information about lateral CA than radial edges. For each computation block, the direction of the edge may e.g. be given by a line or vector extending between the largest SI values. An example is shown in FIG. 12, in which the small squares represent SI pixels, the large squares represent two computation blocks BL1, BL2 each containing 8×8 SI pixels, and the edge direction is given by a line between the two SI pixels having the largest SI values (dark squares) of each computation block. Vectors n0, n1 designate radial vectors from the IRF to a block reference point of the respective computation block, and v0, v1 designate internal block vectors (“edge vectors”) that extend between the largest SI values. In the illustrated example, the block reference point is a center point of the respective edge vector v0, v1. In a variant, which may result in slightly less accurate discrimination between radial and transverse edges, the block reference point is a fixed location of the computation block, e.g. its center point. By consistent definition of the directions of the vectors, which each are normalized to length 1, step 603 may compute the absolute value of the scalar (dot) product between the radial vector and the edge vector and compare the absolute value to a threshold, Tmax, which may be 0.5 or less (corresponding to angle between the vectors of at least)45°). A tangential edge is identified if the absolute value falls below the threshold. In the example of FIG. 12, the test for tangential edges is: ∥dot(n0·v0)∥<Tmax and ∥dot(n1·v1)∥<Tmax, resulting in computation block BL2 being identified to contain a tangential edge. The test may be based on more than the two largest SI values for each computation block, wherein edge vectors are formed between each pair of these SI values, and the test is passed if all or a majority of the edge vectors are deemed to be tangential edges. Step 603 may exclude the computation blocks that are dominated by radial edges in at least one of CCP and RCP. Alternatively, step 603 may only exclude the computation blocks that are dominated by radial edges in both CCP and RCP.

Step 604 corresponds to step 501 in FIG. 5 and sets CCP (red or blue) to be processed by steps 605-619. In a second repetition, step 604 sets the other of the red and blue color planes as CCP.

Steps 605-607 corresponds to step 502 in FIG. 5 and operates on the SI images for CCP and RCP, and the associated computation blocks. In one embodiment, steps 605-607 sequentially process the computation blocks within predefined search regions in the respective SI image to identify, for each search region, a number of edge-containing blocks not in excess of the above-mentioned block number limit (#NB) for each search region. The search regions thereby define a spatial data structure. In one example, the search regions are defined as rings centered on IRP (with the innermost search region being a circle). An example of such search regions SR is given in FIG. 10(A). In this example, the rings SR are tiled to cover the entire image. The rings may have any shape, such as rectangular, oval or circular (as shown). Circular rings may facilitate mapping of computation blocks to search regions. The ring width may be set equal to or larger than the width of the computation block. The ring width may vary among the rings. A computation block is assigned to a specific ring if its center point falls within the ring. The block number limit (#NB), which sets the maximum number of edge-containing blocks to be identified for each search region SR, is preferably much smaller than the total number of computation blocks within the respective search region SR. In the example with ring-shaped search regions SR, it may be advantageous for the block number limit (#NB) to increase in the radial direction from IRP. For example, if the rings are indexed starting with 1 at IRP, the block number limit may be given by: (constant*ring index/number of rings), with the constant setting the block number limit for the outermost ring. As an alternative to such a linear scaling, the block number limit may be scaled with the area of the respective ring. Many alternatives are conceivable.

Reverting to FIG. 6, step 605 selects one of the search regions and obtains the assigned block number limit (#NB). Step 606 prepares a first list (table) of #NB computation blocks within the search region in CCP, and a second list of #NB computation blocks within the search region in RCP. The lists contain the computation blocks that have the largest characteristic value, e.g. maximum, average or median SI value as determined by step 602. The first and second lists may be generated by sorting all computation blocks by descending characteristic value and selecting the #NB top computation blocks. Step 607 identifies the edge-containing blocks as the mathematical intersection of the lists, i.e. by selecting the computation blocks that are present in both lists, and stores identifiers of the edge-containing blocks in memory. Steps 605-607 are then repeated for each search region in the image. The selection process of steps 605-607 is further exemplified in FIG. 11, which shows a first list T1 for CCP (C1, red), and a second list for RCP (C2, green), sorted by maximum SI value (SIₘₐₓ). In this example, the lists T1, T2 contain 17 computation blocks each, and 6 of these computation blocks are present in both lists T1, T2 and are therefore chosen as edge-containing blocks SB for this search region. For illustration purposes, the computation blocks that are not common to the lists T1, T2 are designated by x, whereas the common computation blocks are designated by BL appended by a block number.

Reverting to FIG. 9, the bottom maps M12 and M23 indicate (by black dots) edge-containing blocks SB that have been identified by executing steps 605-607 for the seven innermost search regions SR in FIG. 10(A) for both CCP=C1 and CCP=C3. Map M12 shows edge-containing blocks SB identified for SI images SI1 (CCP=C1) and SI2 (RCP=C2), and map M23 shows edge-containing blocks SB for SI images SI2 (RCP=C2) and SI3 (CCP=C3). It is understood that by steps 605-607 the identified edge-containing blocks form a (minor) subset of the available computation blocks. Further, the provision of a block number limit (#NB) increases the likelihood that the edge-containing blocks SB are well-dispersed among the search regions SR.

In an alternative embodiment (not shown in FIG. 6), step 606 computes a comparison parameter for all computation blocks within the search region and prepares a single list (table) in which the computation blocks are sorted by magnitude of the comparison parameter. The comparison parameter may be a functional combination of one or more characteristic values of the computation block in CCP and one or more characteristic values of the computation block in RCP and is designed to indicate presence of significant edges in both CCP and RCP. In one example, the comparison parameter is given by: SI_{max,CCP}·SI_{min,CCP+RCP}/SI_{max,CCP+RCP}, where SI_{max,CCP} is the maximum SI value within the computation block in CCP, SI_{min,CCP+RCP} is the minimum SI value within CCP and RCP, and SI_{min,CCP+RCP} is the maximum SI value within CCP and RCP. In a variant, the comparison parameter is a weighted combination of the maximum SI values within the computation block in CCP and RCP. Step 607 identifies the edge-containing blocks by selecting #NB computation blocks from the sorted list, e.g. those with largest magnitude of the comparison parameter.

It should be noted that the search regions SR need not cover the entire image. In one example, only every second ring defines a search region, as illustrated by black rings in FIG. 10(B). The search regions SR may alternatively be defined by cells of a grid structure, e.g. a rectilinear grid, curvilinear grid or hexagonal grid. In one example, FIG. 10(C) shows search regions SR defined as rectangular cells in a rectilinear grid, where every second cell (black) defines a search region SR. In another example, every cell may define a search region SR. Search regions defined by cells in a two-dimensional grid may be processed by steps 605-607 in complete analogy with the examples given above for ring-shaped search regions. It should be realized that the use of search regions defined by cells in a two-dimensional grid increases the likelihood that the edge-containing blocks are well-dispersed both radially and angularly over the image.

In a further alternative embodiment (not shown in FIG. 6), which also makes use of the above-described comparison parameter, steps 605-607 are replaced by a step of computing the comparison parameter for each computation block and a step of entering the computation blocks, one by one and based on the comparison parameter, into a hierarchical spatial data structure defined for the image. Preferably, the computation blocks are only added to the hierarchical spatial data structure if their comparison parameter exceeds a predefined threshold. As used herein, a hierarchical spatial data structure denotes a tree data structure of internal nodes, in which each internal node is capable of branching into a predefined number of children until a predefined depth (level) of the tree is reached. Each node corresponds to a region of the image, and this region is recursively subdivided when moving down through the levels in the tree. The root (top) node may correspond to the entire image. The data structure defines a maximum “bucket capacity” of each node, i.e. a maximum number of computation blocks, and when the bucket capacity is exceeded, the computation blocks are moved down in the tree to the next level. When the predefined depth has been reached, the tree data structure automatically keeps the computation blocks with the largest comparison parameters in the nodes on the lowest level. The skilled person realizes that by adding the computation blocks to such a hierarchical spatial data structure, the spatial data structure effectively divides the image into cells in a two-dimensional grid, where the size of the cells is given by the depth of the hierarchical spatial data structure, and each cell is allowed to hold a maximum number (#NB) of edge-containing blocks given by the bucket capacity. One example of a hierarchical spatial data structure is a quadtree, in which each node is capable of branching into exactly four children and each region is subdivided into four quadrants when moving down through the levels of the tree. FIG. 10(D) shows such a quadtree with a bucket capacity of 1 and a depth of 3 as mapped to an image after entry of computation blocks A-F. FIG. 10(E) shows the corresponding tree data structure, where the populated nodes store both the comparison parameter value and the coordinates of the computation block. It should be noted that the quadtree of FIG. 10(D) actually defines search regions (cells) given by the lowest level in the tree data structure, but that many of these search regions are empty at the instant shown in FIG. 10(D). This is more clearly illustrated in FIG. 10(E), in which empty search regions SR corresponding to the lowest level of the tree data structure are shown by addition of dashed lines. The skilled person realizes that after entry of all computation blocks, the hierarchical spatial data structure (exemplified as a quadtree in FIGS. 10(D)-10(E)) will hold edge-containing blocks that are well-dispersed both radially and angularly over the image. The use of a hierarchical spatial data structure is a processing efficient way of identifying a sparse set of edge-containing blocks with good distribution across the image.

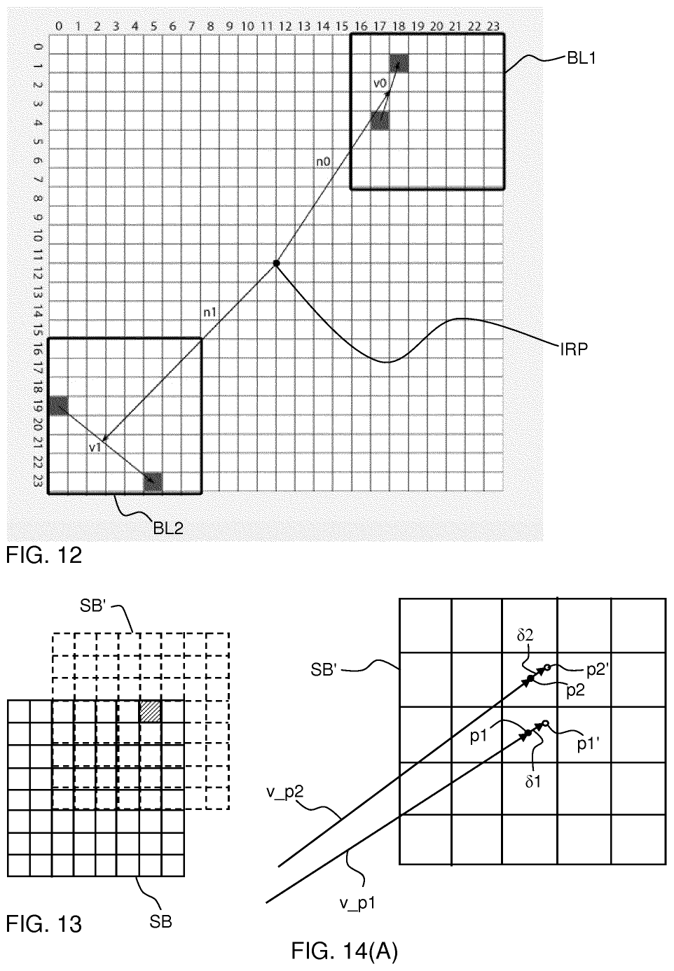

Reverting to FIG. 6, step 608 redefines each of the edge-containing blocks SB that were identified in steps 605-607 by shifting the respective block to be at least approximately centered on the SI pixel with the largest SI value. The largest SI value may identified in both CCP and RCP, in CCP only, or in RCP only. The redefinition of step 608, which is exemplified in FIG. 13, essentially means that the mask that defines the edge-containing block SB is shifted to a new position in the SI image. Thereby, some adjacent pixels of the original edge-containing block SB may be included in the redefined edge-containing block SB′. In FIG. 13, the SI pixel with the largest SI value is hatched. Step 608 has been found to significantly improve the quality of the corrected image. Centering the edge-containing block to the pixel with maximum SI value increases the likelihood that further large SI values are included in the edge-containing block, since large SI values that represent true edges in the image often form clusters. A larger number of large SI values in the edge-containing blocks improves the quality of the radial scaling factors determined in steps 609-615 (cf. step 503). In a variant, step 608 redefines the edge-containing blocks by changing their extent, i.e. the number of included pixels, e.g. by adding one or more rows and/or columns of pixels to the edge-containing block, optionally so as to center the edge-containing block to the pixel with maximum SI value.

Steps 609-615 correspond to step 503 in FIG. 5 and operates on the edge-containing blocks determined by steps 604-607, optionally redefined by step 608, and the characteristic values of these blocks determined by step 602. In one embodiment, steps 609-615 sequentially process the edge-containing blocks to determine, for each edge-containing block, a radial scaling factor. Specifically, step 609 sequentially selects one of the edge-containing containing blocks. For each selected edge-containing block, steps 610-614 are repeated a predetermined number of times, for a predefined plurality of different radial scaling factors (“test factors”), whereupon step 615 selects and stores one of these test factors in association with the edge-containing block. In one embodiment, step 610 changes the test factor by a multiple of step ε between each repetition of steps 610-614. In one example, the test factor may be set to 1 for the first repetition and then increased from 1 by ε for each of m repetitions, and then decreased from 1 by ε for m repetitions. In one another example, the test factor may be set to 1 for the first repetition and then alternately increased from 1 by ε and decreased from 1 by ε for each of 2m repetitions (1, 1+ε, 1−ε, 1+2ε, 1−2ε, etc). For each test factor, steps 611-614 are executed to compute a match parameter that represents the spatial match between the edge containing block in RCP and the edge containing block in CCP. After the repetitions of steps 611-614 for the edge-containing block, step 615 selects and stores the test factor giving the best spatial match, as indicated by the match parameter. Step 615 may be arranged to only store such selected test factors that fall within predefined validation limits. These validation limits may be set to eliminate test factors that are clearly erroneous, i.e. physically improbable. Validation limits may be predefined for each radial distance from IRP, and the selected test factor may be checked against validation limits for the radial distance of the current edge-containing block.

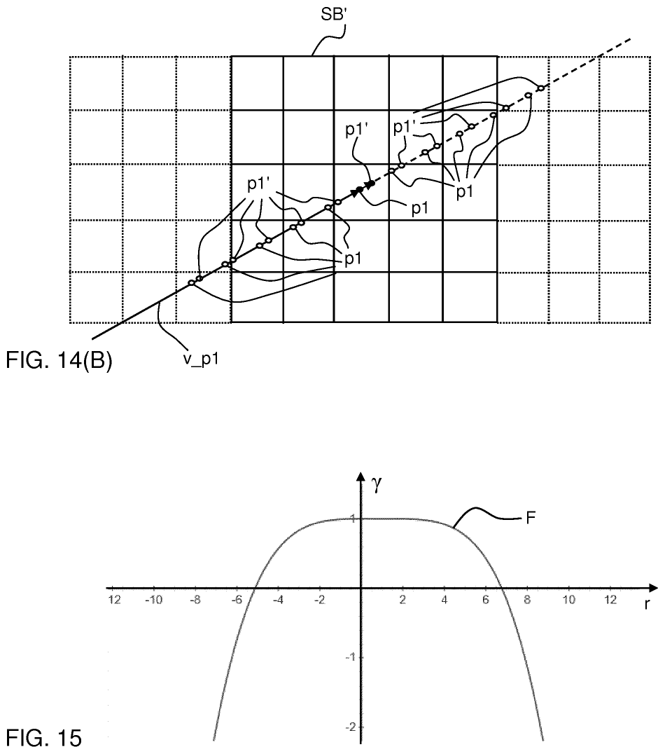

Two different embodiments of steps 611-614 will now be presented with reference to FIGS. 14(A)-14(B).

One of these embodiments is denoted “block match”, shown in FIG. 14(A), and involves all SI values within the edge-containing block SB'. In the block match embodiment, step 611 computes reference SI values (“RSIs”) at reference positions in RCP. The reference positions (only two shown: p1, p2) may be the center points of the SI pixels, and the RSIs may be the SI values of the SI pixels. Step 612 computes scaled positions in CCP by applying the test factor to scale the radial distance from IRP to the respective pixel. In FIG. 14(A), radial vectors from IRP to the pixels p1, p2 are designated by v_p1 and v_p2. As seen, the scaled positions p1′, p2′ are shifted from the respective reference position p1, p2 in the respective radial direction by an amount δ1, δ2 given by the product of the test factor and the respective radial distance. Step 613 computes the SI values at the scaled positions p1′, p2′, these values being denoted “scaled SI values” or “SSIs” herein, by two-dimensional interpolation among the surrounding SI pixels in CCP. Any conceivable interpolation function may be used, including any one of the above-mentioned interpolation functions. Step 614 computes the match parameter based on the RSIs and the SSIs. For example, the match parameter may be an aggregated difference between the RSIs and the SSIs, e.g. given as MAD=Σ∥(RSIi−SSIi)∥ or Σ(1−(MIN(RSIi, SSIi)/MAX(RSIi, SSIi), where RSIi is the RSI for pixel i, SSIi is the SSI for pixel i, and the sum is taken for all pixels within the edge-containing block.

The other embodiment is denoted “radial match”, shown in FIG. 14(B), and only involves SI pixels intersecting with a radial vector extending from IRP through the center point of one selected pixel in the edge-containing block SB′, e.g. the pixel with the largest SI value. Generally, radial match is more processing efficient than block match by enabling use of fewer SSIs and RSIs. In FIG. 14(B), the filled dot p1 is the pixel center point, and v_p1 is such a radial vector. In the radial match embodiment, step 611 computes RSIs at reference positions in RCP. These reference positions include auxiliary positions that are laid out with a predefined spacing to the pixel center point and also include the pixel center point. As indicated in FIG. 14(B), depending on implementation, some of the reference positions may be located outside of the edge-containing block SB′. The RSI at the pixel center point p1 is given by the SI value of the selected pixel, and the RSIs at the added reference points (indicated by open dots p1) are computed by two-dimensional interpolation among the surrounding SI pixels in RCP, using any conceivable interpolation function including the above-mentioned interpolation functions. Step 612 computes scaled positions p1′ in CCP by applying the test factor to scale the radial distance from IRP to the respective reference position p1. In FIG. 14(B), the scaled positions p1′ are shifted from the respective reference position p1 by an amount given by the product of the test factor and the radial distance from IRP to the respective reference position p1. Step 613 computes the SSIs at the scaled positions p1′ by two-dimensional interpolation among the surrounding SI pixels in CCP.

Any conceivable interpolation function may be used, including any one of the above-mentioned interpolation functions. Step 614 computes the match parameter based on the RSIs and the SSIs, e.g. as described for the block match embodiment.

Step 616 corresponds to step 504 in FIG. 5 and operates on the radial scaling factors determined by steps 609-615. Each of these radial scaling factors is associated with a radial distance from IRP, e.g. the radial distance to the center point of the respective edge-containing block. Step 616 adapts one or more coefficients of a predefined function to these pairs of radial distances and radial scaling factors. The function may be a polynomial of any order, e.g. 2, 3, 4, 5 or 6, or any other relation. In such a polynomial, some coefficients may be fixed, e.g. set to zero. The function with the adapted coefficients forms the spatial scaling function. FIG. 15 shows an example of a spatial scaling function F (5th order polynomial) which relates radial scaling y to radial distance r from IRP.

Steps 617-620 correspond to step 505 in FIG. 5 and operates on the spatial scaling function F and the values of the image pixels in the original Bayer image (RD). In one embodiment, steps 617-620 sequentially process the image pixels to determine a rescaled color value for the respective image pixel. For each image pixel selected by step 617, step 618 computes a rescaled pixel location based on the original pixel location, e.g. the pixel center point, and the spatial scaling function F. Then, step 619 computes a rescaled color value at the rescaled pixel location by two-dimensional interpolation among the pixel values in CCP. Step 620 stores the rescaled pixel value for the selected image pixel. When steps 617-620 have been executed for all image pixels, a rescaled color plane has been formed for CCP (color plane C1). The method then proceeds to generate another rescaled color plane by executing steps 604-620 for another CCP (color plane C3). The rescaled color planes and the reference color plane collectively form a mosaiced image which has been corrected for lateral CA.

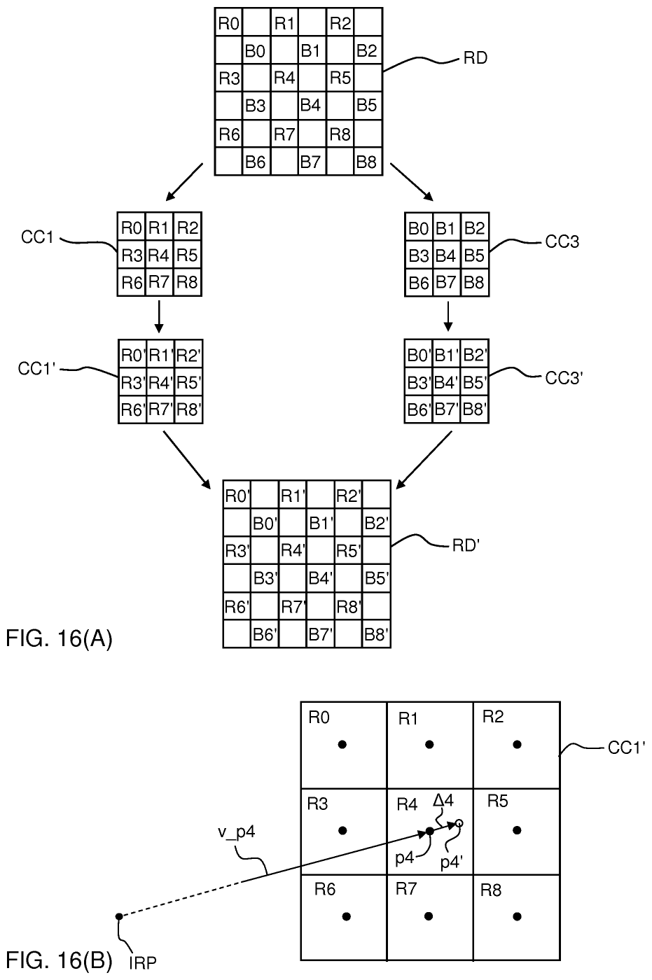

FIGS. 16(A)-16(B) exemplifies the rescaling according to steps 617-620, for a small part of a Bayer image RD. FIG. 16(A) illustrates an optional concatenation procedure, which may be implemented to enable the rescaling to be performed on a GPU. The image pixels containing red color values in the Bayer image RD are arranged side by side in a concatenated red color plane CC1. Similarly, in the second repetition of steps 604-620, a concatenated blue color plane CC3 is formed by the image pixels containing blue color values. Steps 617-620 are then executed for CC1, CC3, as exemplified in FIG. 16(B), producing a respective rescaled color plane CC 1′, CC3′. The rescaled color planes are then written back to the original Bayer image, forming a corrected Bayer image RD′. FIG. 16(B) illustrates the computation of a rescaled pixel value for pixel R4. A radial scaling factor is obtained from the function F for the radial distance to the pixel location p4, given by the length of vector v_p4. A displacement value Δ4 is computed by multiplying the radial scaling factor with the radial distance. The rescaled pixel location p4′ is the obtained by adding the displacement value Δ4 to the vector v_p4. A rescaled pixel value is then computed at the location p4′ by two-dimensional interpolation among the red pixel values, e.g. the illustrated pixels R0-R8. Any conceivable interpolation function may be used, including any one of the above-mentioned interpolation functions. In an alternative implementation, the rescaling according to steps 617-620 is instead made in the color planes C1, C3 of the original Bayer image.

Reverting to FIG. 6, step 621 operates a demosaicing algorithm on the corrected mosaiced image to generate three interpolated color planes [symbol] (FIG. 1) that form a demosaiced image corrected for lateral CA. Any available demosaicing algorithm may be used, including any one of those mentioned in relation to FIG. 1.

The method in FIG. 6 may also be used for processing a demosaiced image, by treating the demosaiced image as a mosaiced image, i.e. by ignoring the interpolated color values in the interpolated color planes [symbol] However, the method of FIG. 6 may alternatively be adapted to process all color values in the interpolated color planes [symbol] Essentially all steps of FIG. 6 may remain the same, except that step 601 may use a different selection of color values to be included in the local regions for computation of the SI values, e.g. by including the color values of all image pixels within the local region in the respective color plane. Alternatively, the SI values may be replaced by any other suitable “edge value” that indicates the magnitude of gradients (edge elements) in the vicinity of the image pixels. In a further variant, step 601 is omitted and a conventional edge detection algorithm is operated on the respective color plane to detect edge elements within the computation blocks and characteristic values for the included edge elements. In one non-limiting example, the edge elements are detected by operating a Canny edge detector on the respective color plane.

1. A computer-implemented method of processing a digital color image for correction of lateral chromatic aberration, the digital color image comprising color values in a first, second and third color plane, image pixels of the digital color image being associated with a color value in at least one of the first, second and third color planes, said method comprising, for a current color plane among the second and third color planes:
identifying, in the digital color image, selected blocks comprising one or more intensity edges in both the current color plane and the first color plane, wherein the selected blocks are identified within each of a plurality of predefined search regions distributed over the digital color image;
determining, for each selected block, a radial scaling factor for the current color plane, the radial scaling factor being determined to minimize a measure of difference between the one or more intensity edges in the current color plane and the one or more intensity edges in the first color plane;
processing the radial scaling factors of the selected blocks to determine a spatial scaling function that relates radial scaling to radial distance from an image reference point of the digital color image; and
recalculating color values of the current color plane for at least a subset of the image pixels by computing an interpolated color value for the respective image pixel at an updated pixel location given by the spatial scaling function for the respective image pixel.

2. The computer-implemented method of claim 1, wherein each search region is associated with a block number limit, which defines a maximum number of selected blocks to be identified within the search region.

3. The computer-implemented method of claim 1, wherein the search regions comprise ring-shaped regions centered on the image reference point and located at different radial distances from the image reference point.

4. The computer-implemented method of claim 1, wherein the search regions are defined by cells in a predefined grid structure.

5. The computer-implemented method of claim 1, wherein each search region comprises predefined computation blocks, and wherein the step of identifying the selected blocks comprises:
identifying, for each search region, the selected blocks as a subset of the computation blocks that contain the relatively largest intensity edges in both the current color plane and the first color plane.

6. The computer-implemented method of claim 1, wherein the digital color image is a mosaiced image in which each image pixel is associated with a color value in one of the first, second and third color planes, and wherein each intensity edge in each of the current color plane and the first color plane is represented by a range value for color values of image pixels in the current color plane and the first color plane, respectively.

7. The computer-implemented method of claim 1, further comprising: obtaining an edge image for each of the current color plane and the first color plane, the edge image comprising edge pixels that spatially correspond to the image pixels in the digital color image, wherein each edge pixel in the current color plane and the first color plane has an edge value representing an intensity gradient within a local region of the spatially corresponding image pixel in the current color plane and the first color plane, respectively, and wherein the selected blocks are identified based on the edge images in the current color plane and the first color plane.

8. The computer-implemented method of claim 7, wherein each search region comprises predefined computation blocks, and wherein the step of identifying the selected blocks comprises: computing, for each of the current color plane and first color plane, a characteristic value for each computation block as a function of the edge values for the edge pixels within the computation block, and identifying, for the respective search region, the selected blocks as function of the characteristic values of the computation blocks in the current color plane and the first color plane.

9. (canceled)

10. The computer-implemented method of claim 8, wherein the computation blocks are processed for elimination of computation blocks dominated by a radial intensity edge in at least one of the current color plane and the first color plane, the radial intensity edge being located to be more parallel than transverse to a radial vector extending from the image reference point to a reference point of the respective computation block.

11. The computer-implemented method of claim 10, wherein the elimination of computation blocks dominated by a radial intensity edge further comprises, for each computation block: defining one or more internal block vectors that extend between the edge pixels that have the largest edge values within the computation block; determining an angle parameter representing one or more angles between the radial vector and the one or more internal block vectors; and comparing the angle parameter to a predefined threshold.

12. The computer-implemented method of claim 8, wherein the step of identifying the selected blocks comprises: selecting a subset of the computation blocks, and forming the selected blocks by redefining the extent of each computation block in the subset so as to shift a center point of the computation block towards a selected edge pixel within the computation block.

13. (canceled)

14. The computer-implemented method of claim 8, wherein the step of identifying the selected blocks comprises:
preparing a first list of a predefined number of computation blocks within the respective search region sorted by characteristic value in the current color plane, preparing a second list of the predefined number of computation blocks within the respective search region sorted by characteristic value in the first color plane, and selecting the selected blocks within the respective search region as the mathematical intersection of the first and second lists, wherein the predefined number is set to the block number limit.

15. The computer-implemented method of claim 8, wherein the step of identifying the selected blocks comprises:
computing a comparison parameter value as a function of the characteristic values in the current color plane and the first color plane for each computation block within the respective search region; and selecting, for the respective search region, a predefined number of computation blocks based on the comparison parameter values, wherein the comparison parameter value is computed to indicate presence of significant intensity edges in both the current color plane and the first color plane, and wherein the predefined number does not exceed the block number limit for the respective search region.

16. The computer-implemented method of claim 15, wherein the step of identifying the selected blocks further comprises: adding the computation blocks to a hierarchical spatial data structure, such as a quadtree, corresponding to the digital color image, wherein the hierarchical spatial data structure is assigned a depth that defines the extent and location of the computation blocks, and a bucket limit that corresponds to the block number limit.

17. The computer-implemented method of claim 8, wherein the step of determining the radial scaling factor comprises:
repeatedly applying different test factors to edge values of edge pixels within the selected block, computing the measure of difference for each test factor, and selecting the radial scaling factor as a function of the test factor yielding the smallest measure of difference.

18. The computer-implemented method of claim 17, wherein each test factor is applied by computing radially offset locations for selected locations within the selected block, generating interpolated edge values at the radially offset locations in the current color plane, obtaining reference edge values at the selected locations in the first color plane, and computing the measure of difference as a function of the interpolated edge values and the reference edge values.

19-22. (canceled)

23. The computer-implemented method of claim 7, wherein the edge value for the respective edge pixel in the current color plane and the reference color plane is a range value for the color values within the local region of the spatially corresponding image pixel in the current color plane and the first color plane, respectively.

24-25. (canceled)

26. The computer-implemented method of claim 1, wherein the spatial scaling function is determined by adapting one or more coefficients of a predefined function, which relates radial scaling to radial distance, to data pairs formed by the radial scaling factors and radial distances for the selected blocks.

27. A non-transitory computer-readable medium comprising computer instructions which, when executed by a processor, cause the processor to perform the method of claim 1.

28. A device for processing a digital color image for correction of lateral chromatic aberration, the digital color image comprising color values in a first, second and third color plane, image pixels of the digital color image being associated with a color value in at least one of the first, second and third color planes, said device being configured to, for a current color plane among the second and third color planes:
identify, in the digital color image, selected blocks comprising one or more intensity edges in both the current color plane and the first color plane, wherein the selected blocks are identified within each of a plurality of predefined search regions distributed over the digital color image;
determine, for each selected block, a radial scaling factor for the current color plane, the radial scaling factor being determined to minimize a measure of difference between the one or more intensity edges in the current color plane and the one or more intensity edges in the first color plane;
process the radial scaling factors of the selected blocks to determine a spatial scaling function that relates radial scaling to radial distance from an image reference point of the digital color image; and
recalculate color values of the current color plane for at least a subset of the image pixels by computing an interpolated color value for the respective image pixel at an updated pixel location given by the spatial scaling function for the respective image pixel.
